(19) United States
(12) Patent Application Publication
(10) Pub. No.: US 2005/0169523 A1
(43) Pub. Date: Aug. 4, 2005

(54) Image processing with information associated with image data

(76) Inventor: Ikuo Hayaishi, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/004,618

(22) Filed: Dec. 3, 2004

(30) Foreign Application Priority Data
Dec. 5, 2003 (JP) 2003-407664

(51) Int. Cl. G06K 9/00

(52) U.S. Cl. 382/167

(57) ABSTRACT

Image processing control information GI/shooting information SI associated with the obtained image data GD is obtained by an image processing control information GI/shooting information SI obtaining module M2. The obtained image processing control information GI/shooting information SI is modified in accordance with the image output apparatus by an image processing control information GI/shooting information SI modification module M3 using modification information obtained by a modification information obtaining module M4. Correction amounts determined using the results of analysis by a correction amount determining module are changed to reflect the modified image processing control information GI/shooting information SI by a correction amount changing module M8. Image processing of the image data GD is executed by an image processing module M5 using the changed correction amounts.

### CROSS REFERENCE TO RELATED APPLICATION

This application relates to and claims priority from Japanese Patent Application No. 2003-407664, filed on Dec. 5, 2003, the entire disclosure of which is incorporated by reference.

### BACKGROUND OF THE INVENTION

1. Field of the Invention

The present invention relates to a technology to execute image processing of image data using information associated with the image data.

2. Description of the Related Art

A technology is known by which to associate image processing control information that describes the image processing conditions for image data with the image data. The image processing control information is configured in accordance with the combination of the image generating apparatus, such as a digital still camera, and the output apparatus, such as a printing apparatus, in order to increase the image quality of the output images output from the output apparatus. Therefore, if the image processing apparatus carries out image processing (image quality adjustment) of the image data based on the image processing control information (image processing conditions) associated with the image data, output images that take into account the image output characteristics of the output apparatus can be obtained.

However, in the prior art technology described above, because the image processing control information is configured in accordance with the image output characteristics of a specific image output apparatus, when an image output apparatus having image output characteristics different from those of the specific image output apparatus is used, image output quality cannot necessarily be improved, i.e., the image quality of the images output by the two apparatuses cannot be harmonized.

In particular, not only do the color areas vary between the printing apparatus and the display apparatus, but the images themselves are viewed via reflected light and transmitted light, respectively. Consequently, the image quality of the output images from the printing apparatus and the display apparatus cannot be harmonized simply by harmonizing the color spaces between the two apparatuses.

### SUMMARY OF THE INVENTION

An object of the present invention is to resolve the problems described above, and to obtain through a different image output apparatus, using image processing control information that is compatible with a specific image output apparatus, output images having an image quality equivalent to that of the images output by the specific image output apparatus, and thereby to improve output image quality.

In order to resolve the above problems, a first aspect of the present invention provides an image processing method by which to carry out image processing of image data using image processing control information that prescribes image processing conditions. The image processing method of the first aspect of the present invention includes the steps of obtaining image data, obtaining image processing control information associated with the obtained image data, obtaining modification information for modifying the image processing control information in accordance with the image output characteristics of the image output apparatus to which the image-processed image data is to be output, modifying the obtained image processing control information using the obtained modification information, and executing image processing of the obtained image data using the modified image processing control information.

According to the image processing method of the first aspect, because the image processing control information is modified using modification information for modifying the image processing control information in accordance with the image output characteristics of the image output apparatus and the image data is subjected to image processing using the modified image processing control information, output images having an equivalent image quality can be obtained from a different image output apparatus and the image quality of the output images can be improved using the image processing control information applicable to a specific image output apparatus.

In the image processing method pertaining to the first aspect of the present invention, it is acceptable if the image processing control information is generated in accordance with the image output characteristics of a first image output apparatus, the image output apparatus is a second image output apparatus having image output characteristics that differ from those of the first image output apparatus, and the modification information is information that brings the output images from the second image output apparatus closer in quality to the output images from the first image output apparatus. In this case, the output images from the second image output apparatus can be brought closer in quality to the output image from the first image output apparatus by modifying the image processing control information generated in accordance with the image output characteristics of the first image output apparatus using modification information.

In the image processing method pertaining to the first aspect of the present invention, it is acceptable if the first image output apparatus is a printing apparatus, the second image output apparatus is a small-screen display apparatus, the image processing control information describes whether or not at least one of either noise reduction or sharpness processing is to be carried out to the image data, and modification of the image processing control information is performed by modifying the image processing control information such that one of either noise reduction or sharpness processing is not to be carried out to the image data. In this case, by not executing at least one of either noise reduction or sharpness processing, the results of which are difficult to check on the small-screen display device, the burden on the resources of time and processing capacity required for image processing can be reduced.

In the image processing method pertaining to the first aspect of the present invention, it is acceptable if the image processing carried out to the image data involves the steps of obtaining characteristic amounts regarding image quality by analyzing the image data, determining correction amounts to be applied to the image data using standard amounts comprising image quality standards and the obtained characteristic amounts, changing the determined correction amounts using the modified image processing control information, and applying the changed correction amounts to the image data. In this case, correction amounts suitable for each individual item of image data can be obtained, and the correction amounts can further be harmonized with the image output apparatus via the modified image processing control information.

In the image processing method pertaining to the first aspect of the present invention, it is acceptable if the image processing of the image data involves the steps of analyzing the image data and obtaining analysis values for each of multiple image quality parameters that indicate the image quality of the image data, obtaining multiple standard values comprising standards for the multiple image quality parameters, determining correction amounts to be applied to the multiple image quality parameters for the image data using the obtained multiple standard values and the obtained multiple analysis values, changing the determined correction amounts using the modified image processing control information, and applying the changed correction amounts to the multiple image quality parameters for the image data. In this case, correction amounts suitable for each individual item of image data can be obtained, and the correction amounts for the various image quality parameters can further be harmonized with the image output apparatus via the modified image processing control information.

In the image processing method pertaining to the first aspect of the present invention, it is acceptable if the modification information is obtained from a modification information storage module that stores the modification information. In this case, necessary modification information can be obtained immediately from the modification information storage module.

In the image processing method pertaining to the first aspect of the present invention, it is acceptable if the modification information is included in the image processing control information. In this case, the image processing control information can be modified to information suitable for the image output apparatus using only the image processing control information.

In the image processing method pertaining to the first aspect of the present invention, it is also acceptable if the modification information is generated based on the image output characteristics of the image output apparatus and the modification information is obtained by obtaining the generated modification information. In this case, modification information compatible with the image output apparatus can always be obtained.

A second aspect of the present invention provides an image processing method by which image processing of image data is executed using at least one of either image processing control information that prescribes image processing conditions or shooting information pertaining to the time of shooting. The image processing method of the second aspect of the present invention includes the steps of obtaining image data, obtaining at least one of either the image processing control information or the shooting information associated with the obtained image data, determining correction amounts to be applied to the obtained image data using at least one of either the obtained image processing control information or shooting information, obtaining modification information for correcting the determined correction amounts in accordance with the image output characteristics of the image output apparatus to which the image-processed image data is to be output, modifying the correction amounts using the obtained modification information, and executing image processing of the obtained image data using the modified correction information.

According to the image processing method of the second aspect of the present invention, because correction amounts to be applied to the obtained image data are determined using at least one of either the obtained image processing control information or shooting information, the correction amounts are modified using modification information for modifying the determined correction amounts in accordance with the image output characteristics of the image output apparatus, and image processing of the obtained image data is carried out using the modified correction information, output images of equivalent image quality can be obtained from a different image output apparatus and the image quality of output images can be improved using image processing control information applicable to a specific image output apparatus.

In the image processing method pertaining to the second aspect of the present invention, it is acceptable if the correction amounts are determined based on the image output characteristics of the first image output apparatus, the image output apparatus is a second image output apparatus having image output characteristics different from those of the first image output apparatus, and the modification information is information for modifying the correction amounts in order to bring the output images from the second image output apparatus closer in quality to the output images from the first image output apparatus. In this case, the output images from the second image output apparatus can be brought closer in quality to the output images from the first image output apparatus by modifying the correction amounts generated in accordance with the image output characteristics of the first image output apparatus using the modification information.

In the image processing method pertaining to the second aspect of the present invention, it is acceptable if the first image output apparatus is a printing apparatus, the second image output apparatus is a small-screen display apparatus, determination of the correction amounts includes determination of a correction amount for at least one of either noise reduction or sharpness processing for the image data, and modification of the correction amounts is carried out by modifying the correction amounts such that at least one of either noise reduction or sharpness processing is not to be performed to the image data regardless of the determined correction amounts. In this case, by not executing at least one of either noise reduction or sharpness processing, the results of which are difficult to check on the small-screen display device, the burden on the resources of time and processing capacity required for image processing can be reduced.

In the image processing method pertaining to the second aspect of the present invention, it is acceptable if the correction amount determination is carried out by (i) analyzing the image data and obtaining analysis values for each of multiple image quality parameters that indicate the image quality of the image data, (ii) obtaining multiple standard values comprising standards for the multiple image quality parameters, and (iii) determining parameter correction amounts to be applied to the multiple image quality parameters for the image data using at least one of either the image processing control information or the shooting information, the obtained multiple standard values and the obtained multiple analysis values, the correction amount modification is performed by modifying the parameter correction amounts, and the image processing of the image data is carried out by applying the modified parameter correction amounts to the multiple image quality parameters for the image data. In this case, parameter correction amounts suitable for each individual item of image data can be obtained, and the parameter correction amounts can further be harmonized with the image output apparatus via the modified image processing control information.

In the image processing method pertaining to the second aspect of the present invention, it is acceptable if the modification information is obtained from a modification information storage module that stores the modification information, or if the modification information is generated based on the image output characteristics of the image output apparatus and the modification information is obtained by obtaining the generated modification information. In this case, necessary modification information can be obtained immediately from the modification information storage module, and modification information compatible with the image output apparatus can always be obtained.

A third aspect of the present invention provides a display method for displaying images using image data associated with image processing control information that prescribes image processing conditions that reflect the image output characteristics of a printing apparatus. The display method of the third aspect of the present invention includes the steps of obtaining image data, obtaining image processing control information associated with the obtained image data, obtaining modification information for modifying the image processing control information such that it reflects the image output characteristics of the display apparatus, modifying the obtained image processing control information using the obtained modification information, executing image processing of the obtained image data using the modified image processing control information, and outputting images using the image data that underwent image processing.

According to the display method pertaining to the third aspect of the present invention, because the image processing control information that prescribes image processing conditions that reflect the image output characteristics of a printing apparatus is modified using modification information such that it reflects the image output characteristics of the display apparatus and the obtained image data is subjected to image processing using the modified image processing control information, output images of an equivalent image quality can be obtained and the quality of output images can be improved on the display apparatus using the image processing control information applicable to the image output characteristics of the printing apparatus.

In the display method pertaining to the third aspect of the present invention, it is acceptable if the image processing of the image data includes the steps of analyzing the image data and obtaining characteristic amounts regarding image quality, determining correction amounts to be applied to the image data using standard values comprising image quality standards and the obtained characteristic amounts, changing the determined correction amounts using the modified image processing control information, and applying the changed correction amounts to the image data. In this case, correction amounts suitable for each individual item of image data can be obtained, and the correction amounts can further be harmonized with the display apparatus via the modified image processing control information.

In the display method pertaining to the third aspect of the present invention, it is acceptable if the image processing of the image data includes the steps of analyzing the image data and obtaining analysis values for each of multiple image quality parameters that indicate the image quality of the image data, obtaining multiple standard values comprising standards for the multiple image quality parameters, determining the correction amounts to be applied to the multiple image quality parameters for the image data using the obtained multiple standard values and the obtained multiple analysis values, changing the determined correction amounts using the modified image processing control information, and applying the changed correction amounts to the multiple image quality parameters for the image data. In this case, correction amounts suitable for each individual item of image data can be obtained, and the correction amounts can further be harmonized with the display apparatus via the modified image processing control information.

In the display method pertaining to the third aspect of the present invention, it is acceptable if the correction amount determination is carried out such that the deviations between the obtained multiple standard values and the obtained multiple analysis values will be reduced or eliminated. In this case, the image quality of the image data may be brought closer to the standard values.

In the display method pertaining to the third aspect of the present invention, it is acceptable if the first image output apparatus is a printing apparatus, the second image output apparatus is a small-screen display apparatus, the image quality parameters include at least one of either the noise parameter or the sharpness parameter, and the modification of the image processing control information is carried out by setting the correction amount for at least one of either the noise parameter or the sharpness parameter to zero. In this case, by not executing at least one of either noise reduction or sharpness processing, the results of which are difficult to check on the small-screen display device, the burden on the resources of time and processing capacity required for image processing can be reduced.

In the display method pertaining to the third aspect of the present invention, it is acceptable if the modification information is obtained from a modification information storage module that stores the modification information. In this case, necessary modification information can be obtained immediately from the modification information storage module.

A fourth aspect of the present invention provides an image processing apparatus that performs image processing of image data using image processing control information that prescribes image processing conditions and outputs to a connected image output apparatus the image-processed image data. The image processing apparatus of the fourth aspect of the present invention includes an image data obtaining module that obtains image data, an image processing control information obtaining module that obtains image processing control information associated with the obtained image data, a modification information obtaining module that obtains for an image output apparatus modification information for modifying the image processing control information in accordance with the image output characteristics of the image output apparatus, an image processing control information modification module that modifies the obtained image processing control information using the obtained modification information, an image processing module that executes image processing of the obtained image data using the modified image processing control information, and an image data output module that outputs to the image output apparatus the image data that underwent image processing.

According to the image processing apparatus pertaining to the fourth aspect of the present invention, the same effects as those obtained in connection with the image processing method of the first aspect of the present invention can be obtained, and the image processing apparatus pertaining to the fourth aspect of the present invention may be realized in various forms in the same manner as the image processing method pertaining to the first aspect of the present invention.

A fifth aspect of the present invention provides an image processing apparatus that performs image processing of image data using at least one of either image processing control information that prescribes image processing conditions or shooting information pertaining to the time of shooting and outputs to a connected image output apparatus the image-processed image data. The image processing apparatus of the fifth aspect of the present invention includes an image data obtaining module that obtains image data, an association information obtaining module that obtains at least one of either image processing control information or shooting information associated with the obtained image data, a correction amount determining module that determines correction amounts to be applied to the obtained image data using at least one of either the obtained image processing control information or shooting information, a modification information obtaining module that obtains for an image output apparatus modification information for modifying the determined correction information in accordance with the image output characteristics of the image output apparatus, a correction amount modification module that modifies the correction amounts using the obtained modification information, an image processing module that executes image processing of the obtained image data using the modified correction information, and an image data output module that outputs to the image output apparatus the image data that underwent image processing.

According to the image processing apparatus pertaining to the fifth aspect of the present invention, the same effects as those obtained in connection with the image processing method of the second aspect of the present invention can be obtained, and the image processing apparatus pertaining to the fifth aspect of the present invention may be realized in various forms in the same manner as the image processing method pertaining to the second aspect of the present invention.

A sixth aspect of the present invention provides a display apparatus that displays images using image data associated with image processing control information that prescribes image processing conditions that reflect the image output characteristics of a printing apparatus. The display apparatus pertaining to the sixth aspect of the present invention includes an image data obtaining module that obtains image data, an image processing control information obtaining module that obtains image processing control information associated with the obtained image data, a modification information obtaining module that obtains modification information for modifying the image processing control information such that it reflects the image output characteristics of the display apparatus, an image processing control information modification module that revises the obtained image processing control information using the obtained modification information, an image processing module that executes image processing of the obtained image data using the modified image processing control information, and an image output module that outputs images using the image data that underwent image processing.

According to the display apparatus pertaining to the sixth aspect of the present invention, the same effects as that obtained in connection with the display method of the third aspect of the present invention can be obtained, and the display apparatus pertaining to the sixth aspect of the present invention may be realized in various forms in the same manner as the display method pertaining to the third aspect of the present invention.

The methods pertaining to the first through third aspects of the present invention may also be realized as a program or as a computer-readable recording medium on which this program is recorded.

### BRIEF DESCRIPTION OF THE DRAWINGS

FIG. 1 is an explanatory drawing showing the basic construction of an image processing system including an image processing apparatus pertaining to a first embodiment;

FIG. 2 is an explanatory drawing showing the basic construction of the image processing apparatus pertaining to the first embodiment;

FIG. 3 is an explanatory drawing showing in a simplified fashion the construction of the image data used in the first embodiment;

FIG. 4 is an explanatory drawing showing an example of the parameters recorded as image processing control information;

FIG. 5 is an explanatory drawing showing an example of the parameters recorded as shooting information;

FIG. 6 is a block diagram of the function modules realized by the control circuit included in a cellular device or display apparatus pertaining to the first embodiment;

FIG. 7 is a flow chart showing the overall processing routine of the image processing executed by the cellular device or display apparatus pertaining to the first embodiment;

FIG. 8 is a flow chart showing the processing routine of the work color space conversion process executed by the cellular device or display apparatus pertaining to the first embodiment;

FIG. 9 is a flow chart showing the processing routine of the correction amount determination process executed by the cellular device or display apparatus pertaining to the first embodiment;

FIG. 10 is a flow chart showing the processing routine of the image quality adjustment process executed by the cellular device or display apparatus pertaining to the first embodiment;

FIG. 11 is a flow chart showing the processing routine of the device color space conversion process executed by the cellular device or display apparatus pertaining to the first embodiment; and

FIG. 12 a block diagram of the function modules realized by the control circuit included in a cellular device or display apparatus pertaining to a second embodiment.

### DETAILED DESCRIPTION OF THE PREFERRED EMBODIMENTS

Embodiments of the image processing apparatus, display apparatus, image processing method and display method pertaining to the present invention will be described below with reference to the drawings.

### First Embodiment

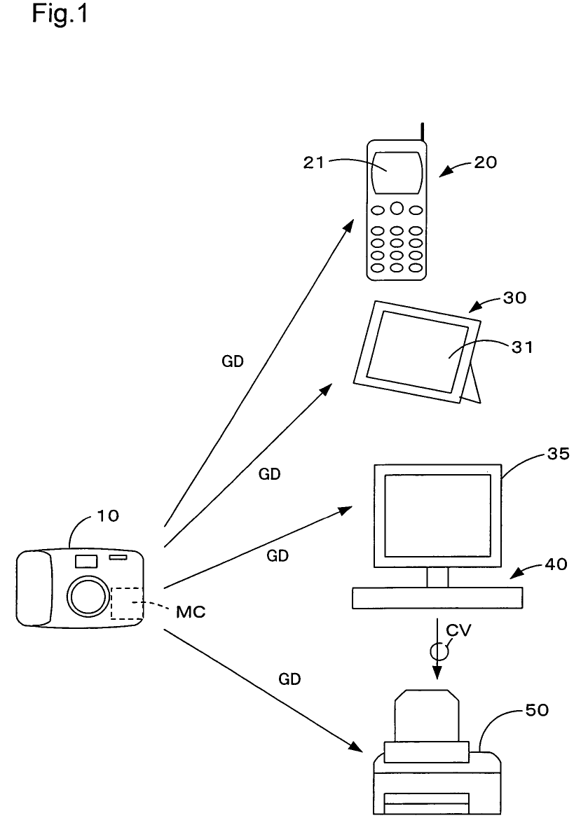

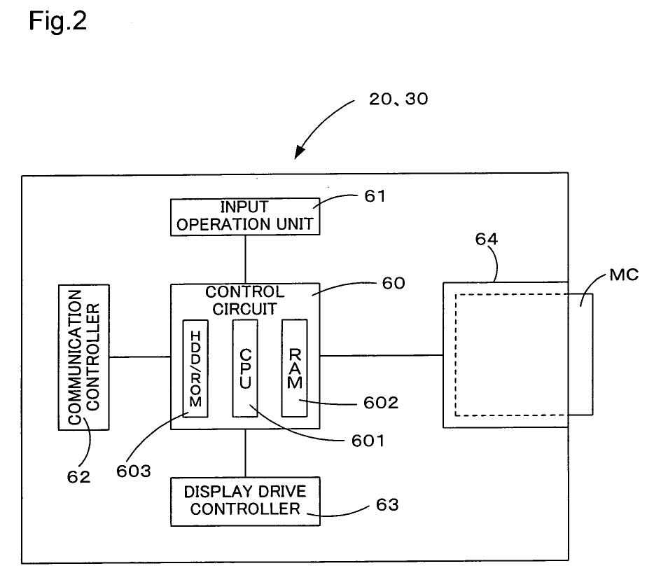

An image processing apparatus (display device) pertaining to a first embodiment and an image processing system that includes such image processing apparatus (display device) will be described with reference to FIGS. 1 and 2. FIG. 1 is an explanatory drawing showing the basic construction of the image processing system that includes the image processing apparatus pertaining to the first embodiment. FIG. 2 is an explanatory drawing showing the basic construction of the image processing apparatus pertaining to the first embodiment.

The image processing system includes a digital still camera 10 comprising an input device that generates image data, a mobile device 20 that functions as a display image output device (display device) and image processing apparatus that execute image processing of image data GD using image processing control information GI associated with the image data GD and output images using the image-processed image data, a display device 30, a personal computer 40 that functions as an image processing apparatus that executes image processing of image data GD in accordance with the connected image output apparatus using image processing control information GI associated with the image data GD, and a color printer 50 that functions as a print image display/output device that outputs images using the image-processed image data.

The digital still camera 10 is a camera that obtains images by causing light information to form images on a digital device (a CCD or a photoelectric conversion element called a ‘photoelectric doubling tube’), and includes a photoelectric conversion circuit incorporating a CCD or the like that converts light information into electricity information, an image obtaining circuit that obtains images via control of the photoelectric conversion circuit, and an image processing circuit that performs processing of the obtained digital images.

The digital still camera 10 saves the obtained images as digital data in a memory card MC that functions as a storage device. The image data stored in the digital still camera 10 is generally saved either in the JPEG data format (a lossy compression format) or the TIFF data format (a lossless data format), but a different format may be used, such as the RAW data format, the GIF data format, or the BMP data format.

When image data GD is generated, the digital still camera 10 can write to the header thereof image processing control information GI that prescribes image processing conditions stored in advance in the memory (such as a ROM) of the digital still camera 10. The digital still camera 10 stores the generated image data GD in the memory card CD or the like.

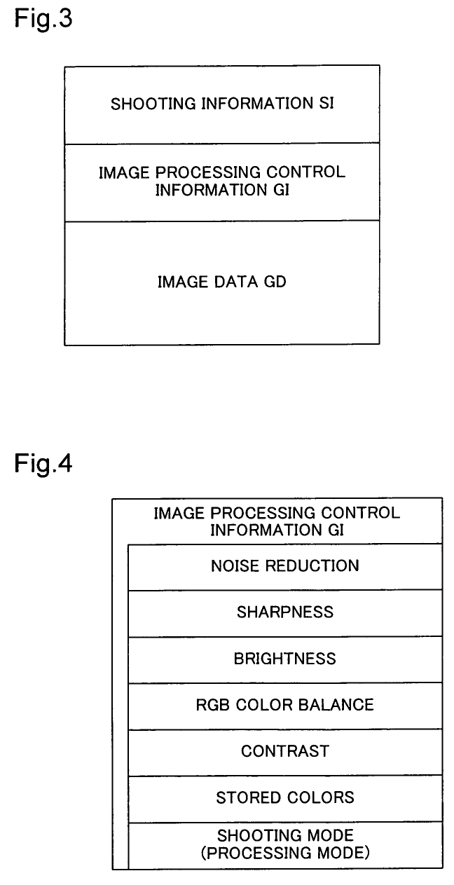

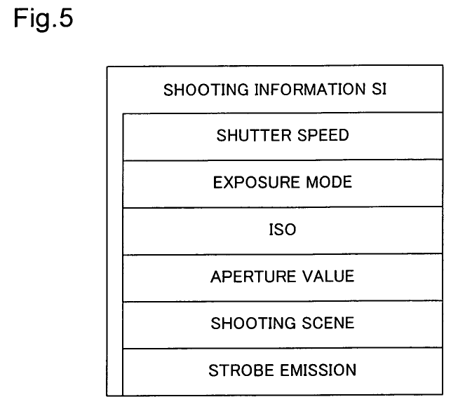

The simplified construction of the image data IMAGE DATA GD, as well as examples of parameters recorded as image processing control information GI and shooting information SI used in this embodiment, will be described with reference to FIGS. 3 through 5. FIG. 3 is an explanatory drawing showing in a simplified fashion the construction of the image data used in the first embodiment. FIG. 4 is an explanatory drawing showing an example of the parameters recorded as image processing control information GI. FIG. 5 is an explanatory drawing showing an example of the parameters recorded as shooting information SI. For purposes of description, the constructions of information and data shown in FIGS. 3 through 5 are shown in a conceptual fashion as data and information stored in memory, for example.

Image data GD includes in the header thereof, for example, image processing control information GI that prescribes the image processing conditions used for image processing of the image data GD and shooting information SI indicating the shooting conditions present at the time of shooting. In other words, the image processing control information GI and shooting information SI correspond to or are associated with each item of image data GD. Image processing control information GI is information that is sought experimentally in advance to ensure that desired output images are obtained when image data generated by a given image data generating device such as the digital still camera 10 is output from a prescribed image output apparatus.

The parameters described as shooting information SI include, for example, the shutter speed, the exposure mode, the ISO, the aperture value, the shooting scene and the emission of strobe light during shooting.

The parameters described as image processing control information GI include, for example, the existence of noise reduction (noise reduction level), sharpness, brightness, RGB color balance, contrast, stored colors and shooting mode (the processing mode during image processing corresponding to the shooting conditions). The image processing control information GI is determined taking into account, for example, the characteristics of image data generation in the digital still camera 10 that generates the image data GD and the image output characteristics of the color printer 50. Therefore, when image data that undergoes image processing using the image processing control information GI is output by an image output apparatus having image output characteristics different from those of the color printer 50, output images similar in quality to those obtained when output is performed by the color printer 50 might not be obtained. Accordingly, in this embodiment, the differences in output image quality are reduced or eliminated by using modification information to modify the image processing control information GI in accordance with the image output characteristics of the image output apparatus in question. Modification information may consist of difference information to harmonize the image processing control information GI with the image output characteristics of the image output apparatus, substitution information to replace the image processing control information GI, or generating information to generate, based on the image processing control information GI, new image processing control information that is compatible with the image output characteristics of the image output apparatus. Such modification information may be included in the image processing control information GI or may be stored in a storage device belonging to an individual image output apparatus.

The mobile device 20 is a mobile terminal having a relatively small display 21, such as a mobile phone or a mobile personal information management device. The mobile device 20 obtains image data from the digital still camera 10, or from a server (not shown) over a network via a recording medium, via wireless communication such as infrared communication or radio communication, or via a cable. The display 21 is a liquid crystal display or an organic EL display, for example, and each display panel has unique image output characteristics.

The display device 30 has a display 31 on which to display images. For example, [the display device 30] is a display device that functions as an electronic photo frame that performs image processing of image data and displays the output images by itself. The display device 30 obtains image data from the digital still camera 10, or from a server (not shown) over a network via a recording medium, via wireless communication such as infrared communication or radio communication, or via a cable. The display 31 is a liquid crystal display or an organic EL display, for example, and each display panel has unique image output characteristics.

The mobile device 20 and display device 30 have the internal circuit construction shown in FIG. 2, for example. The mobile device 20 and display device 30 each include a control circuit 60, an input operation unit 61, a communication control circuit 62, a display drive control circuit 63 and a memory card slot 64.

The control circuit 60 includes a central processing unit (CPU) 601 that executes various types of processing such as image processing, a random-access memory (RAM) 602 that temporarily stores various types of data such as processing results, a hard disk drive (HDD) (or a read-only memory (ROM)) 603 that stores such things as programs executed by the CPU 601 and the modification table used to modify the image processing control information GI.

The input operation unit 61 is an interface unit that receives external input, and in the case of the mobile device 20, is implemented as a key operation unit and/or scroll operation unit, for example. In the case of the display device 30, a touch-panel operation unit may be used as the input operation unit 61.

The communication controller 62 controls communication to exchange image data with the digital still camera 10, the network server or the like. The communication controller 62 executes desired communication requested via the input operation unit 61 and the control circuit 60, for example. Where the mobile device 20 is a mobile phone, audio communication may also be realized via the communication controller 62.

The display drive controller 63 controls the drawing of output images in the display 21, 31. Where the display 21, 31 is a liquid crystal display, the display drive controller 63 forms a dot pattern corresponding to the output image data by performing drive control of the orientation of the liquid crystals based on the output image data sent from the control circuit 60. Where a CRT display is used as the display, the display drive controller 63 forms output images corresponding to the output image data on a fluorescent material by driving a deflection yoke that deflects electron beams emitted from an electron gun.

The memory card slot 64 is a mounting unit used to mount various types of memory cards, and image data recorded on a memory card inserted in the memory card slot 64 is read by the control circuit 60.

The personal computer 40 is a commonly used type of computer that includes a CPU, RAM, hard disk and the like and executes the same type of image processing and processing as the control circuit 60. The personal computer 40 also includes a memory card slot used for mounting of a memory card MC and an I/O terminal used for connecting a connecting cable from the digital still camera 10 or the like.

A display device 35 and color printer 50 are connected to the personal computer 40 as image output devices, and where the personal computer 40 functions as an image processing apparatus, image processing is executed in accordance with the respective image output characteristics of the display device 35 and the color printer 50 using the image processing control information GI.

The color printer 50 is a printer capable of color image output, and comprises an inkjet printer that forms images by discharging ink of the four colors of cyan (C), magenta (M), yellow (Y) and black (K) onto a printing medium to form a dot pattern. Alternatively, [the color printer 50] may be an electrophotographic printer that forms images by transferring and fusing color toner onto a printing medium. In addition to the four ink colors described above, the colors of light cyan (LC) and light magenta (LM) may be used.

Functional Construction of Control Circuit 60 Incorporated in Mobile Device 20 and Display Device 30:

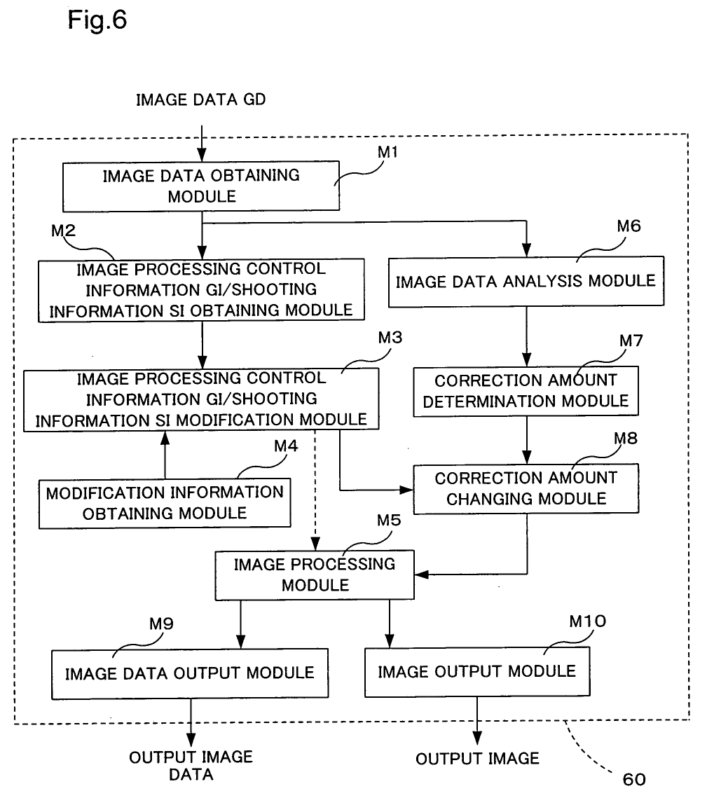

The modules implemented by each control circuit 60 included in the mobile device 20 and the display device 30 will now be described with reference to FIG. 6. FIG. 6 is a block diagram of the function modules implemented by each control circuit 60 included in the mobile device 20 and the display device 30 pertaining to the first embodiment. Each module shown in FIG. 6 is implemented by the CPU alone or as part of the control circuit 60, and may be implemented via either hardware or software. The function modules described below may similarly be implemented by the personal computer 40.

The image data GD to be subjected to image processing is obtained by the image data obtaining module M1. The image processing control information GI/shooting information SI associated with the image data GD is obtained by the image processing control information GI/shooting information SI obtaining module Image processing control information GI/shooting information SI obtaining module M2, and the obtained image processing control information GI/shooting information SI is modified in accordance with the image output apparatus by the image processing control information GI/shooting information SI modification module M3.

Because the image processing control information GI is generally configured to enable the optimal output image (image quality) to be obtained based on the relationship between a specific image data generating device such as the digital still camera 10 and a specific image output apparatus, where image processing based on the image processing control information GI is to be carried out by an image output apparatus different from the specific image output apparatus, it is desired that the image processing control information GI be modified for compatibility with the image output characteristics of the different image output apparatus.

Accordingly, image processing control information GI/shooting information SI modification is carried out by the image processing control information GI/shooting information SI modification module M3 using the modification information obtained by the modification information obtaining module M4. The modification information may be described in the image processing control information GI or may be recorded in advance in the HDD 603 of the control circuit 60.

At the same time, in order to execute image processing of the image data GD using standard values, the image data GD is analyzed by the image data analysis module M6 and correction amounts to be used when performing image processing of the image data GD are determined by the correction amount determination module M7 using the results of this analysis. The determined correction amounts are changed by the correction amount changing module M8 using the modification information in order to reflect the modified image processing control information GI/shooting information SI.

Image processing of the image data GD is carried out by the image processing module M5 using the changed correction amounts. The image-processed image data GD is sent to the display drive controller 63 by the image data output module M9 as output image data. Alternatively, where the control circuit 60 includes an image output module M10, the output image for the image-processed image data GD is output via the image output module M10 to the display 21, 31.

During image processing by the image processing module M5, the changed correction amounts need not be used, and image processing may be carried out using the parameter values described as the modified image processing control information GI as is.

Image Processing by Control Circuit 60 Incorporated in Mobile Device 20 and Display Device 30:

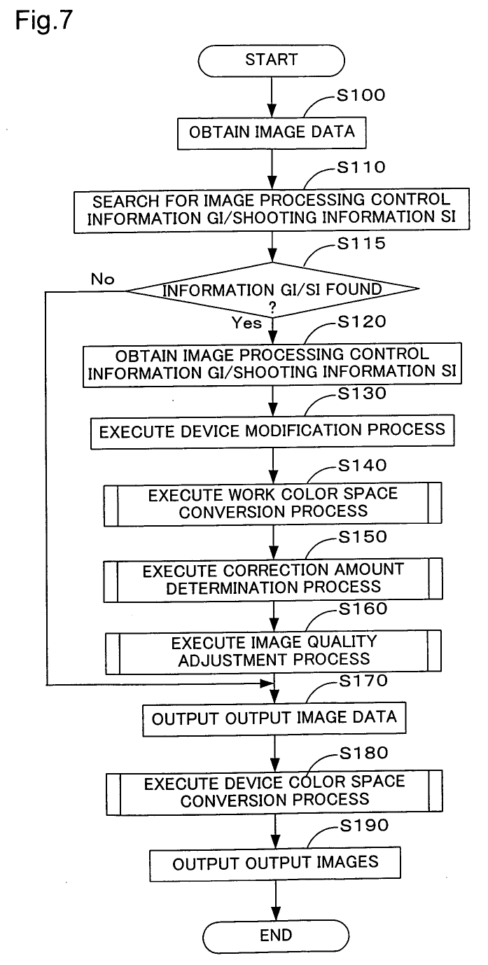

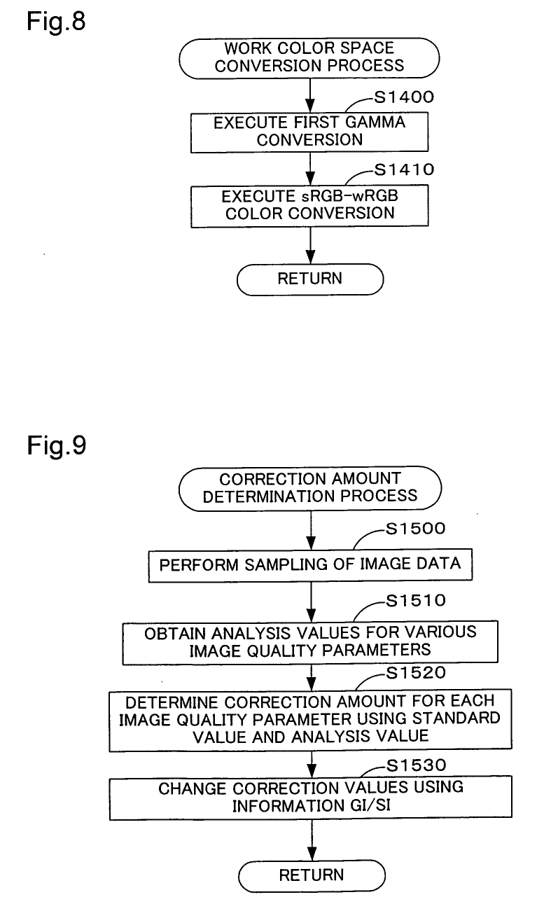

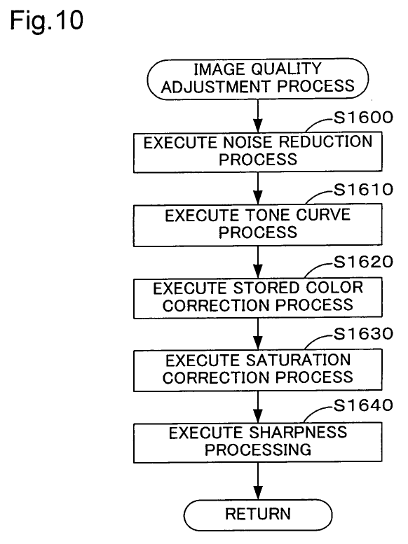

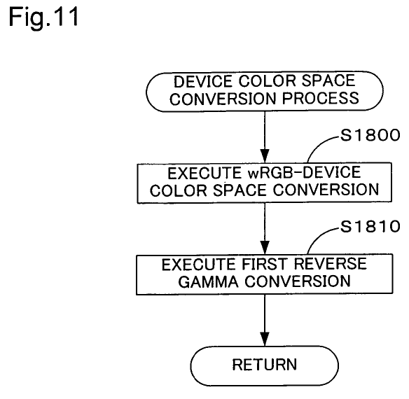

The image processing executed by each control circuit 60 included in the mobile device 20 and display device 30 pertaining to the first embodiment will now be described with reference to FIGS. 7 through 11. FIG. 7 is a flow chart showing the overall processing routine of the image processing executed in the mobile device 20 and display device 30 pertaining to the first embodiment. FIG. 8 is a flow chart showing the processing routine of the work color space conversion process executed in the mobile device 20 and display device 30 pertaining to the first embodiment. FIG. 9 is a flow chart showing the processing routine of the correction amount determination process executed in the mobile device 20 and display device 30 pertaining to the first embodiment. FIG. 10 is a flow chart showing the processing routine of the image quality adjustment process executed in the mobile device 20 and display device 30 pertaining to the first embodiment. FIG. 11 is a flow chart showing the processing routine of the device color space conversion process executed in the mobile device 20 and display device 30 pertaining to the first embodiment.

The image processing carried out in this embodiment is begun when desired image data GD is selected in the mobile device 20 or display device 30 using a key, touch panel or the like, for example. Alternatively, it may be executed when image data GD is received by the mobile device 20 or display device 30.

When image processing is initiated, the control circuit 60 (CPU 601) obtains the selected image data GD and temporarily stores it in the RAM 602 (step S100). The selection of the image data GD may be carried out in the digital still camera 10 connected to the mobile device 20 or display device 30 either wired or wirelessly, for example, or may be made from among the items of image data GD stored in a memory card MC inserted in the mobile device 20 or display device 30. The selection may be made over a network from among multiple items of image data GD stored on a server.

The CPU 601 searches for the image processing control information GI/shooting information SI associated with the selected image data GD (step S110). The CPU 601 searches for the header of the image data GD or searches on the memory card MC or over the network for the image processing control information GI/shooting information SI having a different file format and associated with the image data GD. If the image processing control information GI/shooting information SI is found (i.e., if the search is successful) (YES in step S115), the CPU 601 obtains the image processing control information GI/shooting information SI (step S120). If no such image processing control information GI/shooting information SI can be located, however (NO in step S115), the CPU 601 advances to step S170 without performing image quality adjustment using the image processing control information GI/shooting information SI.

Returning to FIG. 7, the CPU 601 executes device modification (step S130). As described above, the image processing control information GI is generally optimized for the combination of a specific image data generating device and a specific image output apparatus, such as the color printer 50, for example. Because display output images and print output images have color area differences and visual perception differences given that one type of output image is displayed based on transmitted light and the other type of output image is displayed based on reflected light, the appropriate values for white balance, contrast and saturation differ between the two types of images. Therefore, where the assumed specific image output apparatus is not used in connection with the mobile device 20 or display device 30, the image quality of the output images will differ from the image quality of the output images output by the color printer 50.

Accordingly, in this embodiment, in order to partially or completely harmonize the image quality of display output images from the mobile device 20 or display device 30 with the image quality of printing output images from the color printer 50, the image processing control information GI is modified using modification information prepared for each device. The modification information may consist of difference information expressing the differences between (i) the display parameter values comprising the values of image quality parameters used to obtain in the mobile device 20 or display device 30 an display image quality identical to that of print output images, or (ii) new display parameter values to be used in place of the image quality parameter values described in the image processing control information GI.

For example, because different liquid crystal panels tend to have significantly different image output characteristics, it is preferred that different modification information be prepared for each liquid crystal panel. The modification information may be included in the image processing control information GI as one unit of information, or may be stored in the HDD/ROM 603 as unique modification information for each mobile device 20 and display device 30. Furthermore, it may be actively generated in the mobile device 20 or display device 30 based on the image processing control information GI.

The types of information included in the modification information (i.e., the parameter value differences or the substitution parameter values) comprises, for example, information specifying white points, contrast modification information, saturation modification information, hue modification information, information specifying whether noise reduction is to be executed and information specifying whether sharpness processing is to be executed, for example.

(1) Because different image output apparatuses have different color temperatures, the color temperature is adjusted by specifying white points. For example, where the display color temperature is high (9300 k, for example), if the white point specification information is R=(237, 255), G=(255, 251), B (255, 222), the color balance on the display 21, 31 can be harmonized to a certain extent.

(2) Because different image output apparatuses have different reproducible color areas, substantial differences in contrast exist, which leads to substantial differences in image appearance. Accordingly, the contrast can be harmonized to some extent by adjusting the tone curve.

(3) Because different image output apparatuses have different expressed saturations, in order to harmonize the output image output from the color printer 50 with the output image output onto the display 21, 31, for example, saturation must be adjusted.

(4) Where differences in hue exist between the output image output by the color printer 50 and the output image output onto the display 21, 31, correction specifying a color area via color space conversion matrix adjustment, use of memory color correction, HSB or the like may be realized using modification information.

The CPU 601 executes work color space conversion that changes the color space of the obtained image data GD to a work color space (step S140). This work color space conversion process is described below with reference to FIG. 8. This work color space conversion process is a process to change the color space of the image data GD to a color space to be used when the image data undergoes image quality adjustment processing, i.e., to a work color space. By using a color space with a large color area as the work color space, the pixel data comprising the image data after image quality adjustment can be effectively used.

Accordingly, in this embodiment, the color space of the image data GD is converted from the sRGB color space generally used as an RGB color space to the wRGB color space having a larger color area than the sRGB color space.

Because the image data GD obtained from the digital still camera 10 is normally YCbCr color space data, first, it is converted into image data in the sRGB color space used as a standard during image processing. The matrix S well known to persons skilled in the art is used during WCbCr-RGB conversion. Where the obtained image data GD is sRGB image data, on the other hand, color conversion using the matrix S is not necessary. This description assumes that the image data GD is already sRGB color space image data.

The CPU 601 subjects the image data GD to first gamma conversion (step S1400). The color conversion process is normally executed using a device-independent color space such as XYZ or Lab, and an sRGB-XYZ color conversion or an XYZ-wRGB color conversion using a matrix is carried out. In order to increase the processing precision of this color conversion, the I/O characteristic (gamma characteristic) of the image data GD must be linearized. The gamma value used here is the gamma value generally used during reverse gamma conversion carried out when image data is generated by the digital still camera 10.

The CPU 601 subjects the linearized image data GD to sRGB-XYZ color conversion and XYZ-wRGB color conversion using a matrix, thereby converting the image data GD color space to the work color space of wRGB (step S1410), ends this processing routine, and returns to the processing routine of FIG. 7.

Returning to FIG. 7, the CPU 601 executes a correction amount determination process (step S150). This correction amount determination process is described below with reference to FIG. 9. The correction amount determination process in this embodiment is a process to seek correction amounts to be used during so-called automatic image quality adjustment that brings the values of the parameters related to the image quality of the image data GD to values that are closer or identical to standard values.

The CPU 601 performs pixel-by-pixel sampling of the image data GD or of thinned data regarding the image data GD (such as thumbnail image data), or sampling of pixels at prescribed intervals (step S1500). The CPU 601 obtains an analysis value (statistical values, characteristic values) regarding each parameter pertaining to the image quality of the image data GD (image quality parameters) from the sampled pixel data (step S1510).

The CPU 601 obtains the standard value prepared beforehand for each image quality parameter and determines a correction value for each image quality parameter using the standard value and the analysis value (step S1520). More specifically, a correction value is determined, using an arithmetic equation prepared for each image quality parameter, such that the difference between the standard value and the analysis value for each image quality parameter will be eliminated or reduced. In other words, in this embodiment, correction values are determined regarding the image quality of each item of image data GD by analyzing the characteristics thereof. These correction values may be values used as new image quality parameter values, or may be values used to increase or decrease the analysis values for the various image quality parameters.

The CPU 601 changes the correction values determined for the various image quality parameters using the image processing control information GI/shooting information SI (step S1530), ends the current processing routine, and returns to the processing routine of FIG. 7. In other words, using the image quality characteristics for the combination of the image data generating device and the image output device, as well as the shooting conditions present when the image data was created, information (conditions) that cannot be obtained solely from the analysis of the image data GD can be reflected in the correction values determined in accordance with the image quality of the image data GD. In this embodiment, because the image processing control information GI is modified using the modification information such that the images on the mobile device 20 or display device 30 are of the same image quality as the output images from the color printer 50, differences in perceptible image quality attributable to the differences [between the image quality characteristics of the display device and] the image quality characteristics of the image output apparatus can be eliminated or reduced.

Specifically, where the correction values are values used to increase or decrease the analysis values of the various image quality parameters, the amount of such increase or decrease is changed using the image processing control information GI/shooting information SI. Where the correction values are values used as new image quality parameter values, they are changed to new values using the image processing control information GI/shooting information SI. In addition, where manually configured parameters set intentionally by the photo-taker via manual operation exist, the set parameter values may be added to the correction values as is.

The CPU 601 executes image quality adjustment for the image data GD using the changed correction values (step S160). This image quality adjustment process is described below with reference to FIG. 10. The CPU 601 executes noise reduction with regard to the image data GD (step S1600). The noise reduction process may be a process that is either executed or not executed based on the modification information, or may be a process wherein the noise reduction level is modified based on the modification information. The noise reduction process exerts a relatively large processing burden [on the CPU 601]. At the same time, it is generally difficult to check the results of the noise reduction process on a display having a small display screen size. Therefore, the noise reduction process may be skipped on the mobile device 20, which tends to have a small-sized screen display, given the minimal effectiveness of the noise reduction process relative to the processing burden.

Next, the CPU 601 modifies the tone curve using the modified correction values and executes image quality adjustment with regard to the image data GD using the tone curve (step S1610). The image quality adjustment process using this tone curve is carried out in order to adjust the image quality parameters of brightness, color balance and contrast. Tone curve modification is carried out by changing the passing points of the tone curve at modification points set for each image quality parameter, for example.

The CPU 601 then substitutes the colors equivalent to the preset stored colors with colors defined as stored colors (step S1620). Stored colors are defined beforehand as good-looking colors for skin color, sky color, plant color and red color, for example.

The CPU 601 then executes saturation correction (step S1630). Saturation correction using correction values (adjustment amounts) is carried out using the equations below, where the pre-correction values are deemed (Rb, Gb, Bb), the post-correction values are deemed (Ra, Ga, Ba) and the correction values are deemed (R, G, B).

$$\begin{matrix}{R}_{a} = ( {R}_{b} - ( \frac{{R}_{b} + {G}_{b} + {B}_{b}}{3} ) ) \times \frac{R}{100} + {R}_{b} \\ {G}_{a} = ( {G}_{b} - ( \frac{{R}_{b} + {G}_{b} + {B}_{b}}{3} ) ) \times \frac{G}{100} + {G}_{b} \\ {B}_{a} = ( {B}_{b} - ( \frac{{R}_{b} + {G}_{b} + {B}_{b}}{3} ) ) \times \frac{B}{100} + {B}_{b}\end{matrix}$$

The CPU 601 then executes sharpness processing (step S1640), ends the image quality adjustment process, and returns to the processing routine of FIG. 7. The sharpness process may comprise a process that is either executed or not executed based on the modification information, or may comprise a process wherein the sharpness level is modified based on the modification information. It is generally difficult to check the results of the sharpness process on a display having a small display screen size. Therefore, the sharpness process may be skipped on the mobile device 20, which tends to have a small-sized screen display, given the minimal effectiveness of the sharpness process relative to the processing burden.

The CPU 601 then executes work color space conversion to change the color space of the image data GD as to which image quality adjustment has been carried out to a device [color space] (step S1710). This device color space conversion process is described below with reference to FIG. 11. The device color space conversion process is a process to change the image data GD color space from the work color space used when image quality adjustment was carried out to the color space of each image output apparatus. Here, the image output apparatus that performs display output of images (the display) is ordinarily designed for color compatibility with the sRGB color space. On the other hand, some display image output devices (displays) are designed based on a color space unique to the device.

The CPU 601 then subjects the linearized image data GD to wRGB-XYZ color conversion and XYZ-sRGB color conversion or XYZ-device color space color conversion using a matrix, or to wRGB-sRGB color conversion or wRGB-device color space conversion using a lookup table, thereby converting the color space of the image data GD to a device color space (step S1700).

The CPU 601 then performs first reverse gamma conversion with regard to the image data GD (step S1710), ends the current processing routine and returns to the processing routine shown in FIG. 7. In other words, it changes the gamma characteristic of the image data GD to a characteristic compatible with the gamma characteristic of the display 21, 31. Specifically, reverse gamma conversion is performed using the gamma value for the display 21, 31.

The CPU 601 then performs display output of the output images via the display drive controller 63 and ends the processing routine.

As described above, according to the mobile device 20 or display device 30 pertaining to the first embodiment, display output of images having the same image quality as output images output by the color printer 50 can be carried out using the image processing control information GI defined for the combination of the digital still camera 10 and the color printer 50. In other words, while the mobile device 20 and display device 30 have image output characteristics different from those of the color printer 50, the differences in the appearance (image quality) of the output images attributable to differences in these image output characteristics are eliminated or reduced by modifying the image processing control information GI using modification information. Therefore, the image quality of output images from a given image output apparatus can be made closer to or identical with the image quality of output images from a specific image output apparatus using image processing control information GI defined in accordance with the specific image output apparatus.

Furthermore, in the first embodiment, even if each image output apparatus does not include image processing control information GI, by using modification information, output images having an image quality that approximates or matches the image quality of output images from a specific image output apparatus can be output from multiple image output apparatuses.

Moreover, in the first embodiment, when using an mobile device 20 having a small-screen display 21, among the processes executed during image quality adjustment, the noise reduction and sharpness processing, the results of which are difficult to confirm on a small screen, may be skipped. As a result, while main image quality adjustment based on the image processing control information GI can be executed, the processing burden entailed by the image quality adjustment can be reduced and the time required to execute such process can be shortened.

### Second Embodiment

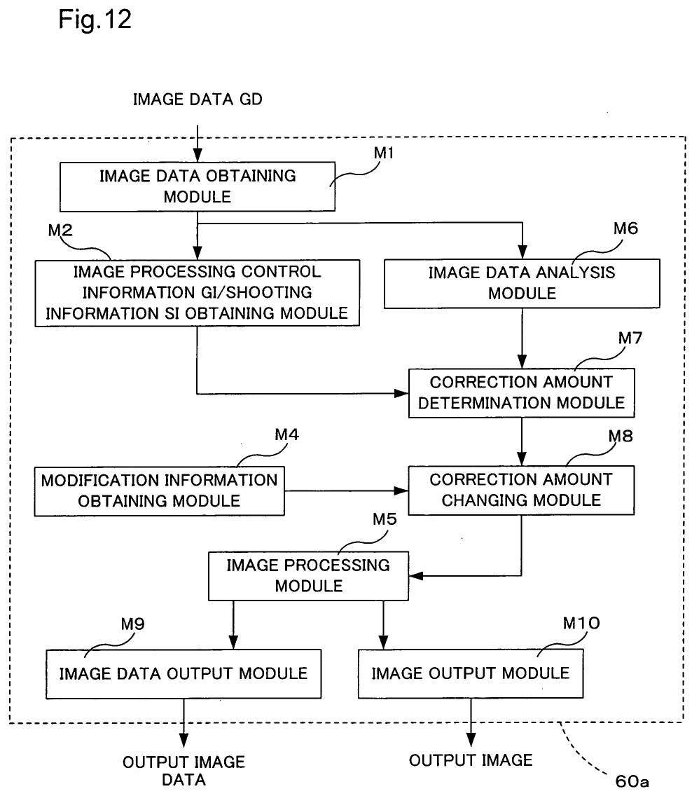

The functional construction of the control circuit 60a included in a mobile device or display device pertaining to a second embodiment will now be described with reference to FIG. 12. FIG. 12 is a block diagram of function modules implemented by a control circuit 60a included in the mobile device or display device pertaining to the second embodiment. Each module shown in FIG. 12 is implemented either by the CPU 601 alone or as a part of control circuit 60a, and may be implemented as either hardware or software. Moreover, the function modules described below may also be implemented by the personal computer 40.

In the second embodiment, the modification information is not used in order to directly modify the image processing control information GI/shooting information SI, but indirectly modifies the image processing control information GI/shooting information SI by modifying the correction amounts determined using the image processing control information GI/shooting information SI. In addition, because the mobile device and display device of the second embodiment have the same basic construction as the mobile device and display device of the first embodiment, the same symbols are used for each, and description thereof is omitted. Furthermore, the image processing executed by the control circuit 60a of the second embodiment is identical to the image processing executed by the control circuit 60 of the first embodiment except for the manner of application of the modification information.

The image data GD to be subjected to image processing is obtained by the image data obtaining module M1. the image processing control information GI/shooting information SI associated with the image data GD is obtained by the image processing control information GI/shooting information SI obtaining module M2.

In order to execute image processing using standard values for the image data GD, the image data GD is analyzed by the image data analysis module M6. The correction amounts to be used during image processing of the image data GD are determined by the correction amount determination module M7 using the analysis results and the image processing control information GI/shooting information SI.

Because the image processing control information GI is generally configured to enable the optimal output images (image quality) to be obtained based on the relationship between a specific image data generating device such as the digital still camera 10 and a specific image output apparatus, where image processing based on the image processing control information GI is carried out by an image output apparatus different from the specific image output apparatus, it is preferred that the correction amounts be modified for compatibility with the image output characteristics of the different image output apparatus.

Accordingly, processing to change the correction amounts using the obtained modification information is carried out by the correction amount changing module M8 using the modification information obtained by the modification information obtaining module M4. The modification information may be included in the image processing control information GI or may be stored in advance in the HDD 603 of the control circuit 60.

Image processing of the image data GD is carried out by the image processing module M5 using the changed correction amounts. The image-processed image data GD is sent to the display drive controller 63 by the image data output module M9 as output image data. Alternatively, where the control circuit 60 includes an image output module M10, output images for the image-processed image data GD are output via the image output module M10 to the display 21, 31.

As described above, according to the mobile device 20 or display device 30 pertaining to the second embodiment, because the correction amounts applied to the image data GD that are determined using the image processing control information GI/shooting information SI and the results of analysis of the image data GD are changed using the modification information, display output of images having the same image quality as output images output by the color printer 50 can be carried out using the image processing control information GI defined for the combination of the digital still camera 10 and the color printer 50. In other words, while the mobile device 20 and display device 30 have image output characteristics different from those of the color printer 50, the differences in the appearance (image quality) of the output images attributable to differences in these image output characteristics are eliminated or reduced by indirectly modifying the image processing control information GI by changing the correction amounts using the modification information.

Furthermore, in the second embodiment, because the correction amounts defined using the image processing control information GI/shooting information SI are changed using the modification information, the image quality of output images from a desired image output apparatus can be made to approximate or match the image quality of output images from a specific image output apparatus via image quality adjustment using not only image processing control information GI defined in accordance with the specific image output apparatus, but also using shooting information SI that indicates the shooting conditions present during shooting.

### Other Embodiments

In the above embodiments, work color space conversion was executed, but the work color space conversion process need not be carried out on the mobile device 20 or the display device 30, which have small reproducible color areas. In this case, because the advantages of a work color space having a large color area are not fully utilized, it is preferred that the work color space conversion process be omitted in order to increase image processing speed.

In the above embodiments, the mobile device 20 and display device 30 are used as the display device and image processing apparatus, but it is acceptable if the personal computer 40 is used as the image processing apparatus and a standalone printer equipped with an image processing function is used as the printed image output apparatus.

In the above embodiments, the processes up to device color space conversion are executed by the mobile device 20 or display device 30, but where the personal computer 40 is used as the image processing apparatus, for example, the device color space conversion process may be executed by the driver of the image output apparatus. In this case, the personal computer 40 sends the image data that has undergone image quality adjustment to the image output apparatus as output image data, and the driver of the image output apparatus executes color conversion using a device color space conversion lookup table, for example, and finally carries out output of the output images.

In addition, the image processing and display processing carried out in the mobile device 20 or display device 30 may be executed not via hardware, but via a printer driver, video driver, or image processing application (program).

The image quality parameters adjusted during image quality adjustment may include shadows and highlights in addition to the parameters described above.

In the above embodiments, a case in which the image processing control information GI was defined so as to be compatible with the color printer 50 was described, but the image processing control information GI may be made compatible with the mobile device 20 or the display device 30. In this case, image quality adjustment may be carried out to the image data to be output to the color printer 50 using modification information defined to modify the image processing control information GI for the mobile device 20 or the like such that it will become compatible with the image output characteristics of the color printer 50.

In the above embodiments, where the output images based on the image data GD are to be output by the color printer 50, image quality adjustment is carried out to the image data GD using the image processing control information GI and not the modification information.

Furthermore, all or part of the image processing carried out in the mobile device 20 or the display device 30 may be carried out in the digital still camera 10. In this case, such processing may be realized by incorporating the image processing functions described in connection with the above embodiments in a retouch application, printer driver or other image data processing application stored in the ROM or the like of the digital still camera 10. The output image data generated by the digital still camera 10 is provided to the mobile device 20 or display device 30 via a cable or memory card MC or via wireless communication. The mobile device 20 or display device 30 that receives the output image data outputs images to the display 21 or 31.

In the above embodiments, image processing and display processing are carried out as software, i.e., as part of a computer program, but they may be implemented using an image processing hardware circuit that includes a logic circuit that executes the above processes (steps). In this case, the burden on the CPU 601 can be reduced and faster processing can be achieved. The image processing hardware circuit may be implemented as a built-in circuit mounted in the digital still camera 10, mobile device 20, display device 30 or color printer 50, or may be mounted in the personal computer 40 as an add-on card.

The image processing apparatus, display device, image processing method, display method, image processing program and display processing program pertaining to the present invention were described above based on embodiments, but the embodiments of the above invention are provided to enable the present invention to be easily understood, and do not limit the present invention in any way. The present invention may be modified or improved within the scope thereof or the claims herein, and naturally incorporates equivalent devices, methods or programs.

1. An image processing method of executing image processing of image data using image processing control information that prescribes image processing conditions, the method comprising:
obtaining said image data;
obtaining said image processing control information associated with said obtained image data;
obtaining modification information for modifying said image processing control information in accordance with the image output characteristics of the image output apparatus to which the image-processed image data is to be output;
modifying said obtained image processing control information using said obtained modification information; and
executing image processing of said obtained image data using said modified image processing control information.

2. An image processing method according to claim 1, wherein said image processing control information is generated in accordance with the image output characteristics of a first image output apparatus, said image output apparatus is a second image output apparatus having image output characteristics that differ from those of said first image output apparatus, and said modification information is information that brings the output images from said second image output apparatus closer in quality to the output images from said first image output apparatus.

3. An image processing method according to claim 2, wherein said first image output apparatus is a printing apparatus, said second image output apparatus is a small-screen display device, said image processing control information describes whether or not at least one of either noise reduction or sharpness processing is to be carried out to said image data, and modification of said image processing control information is performed by modifying said image processing control information such that one of either noise reduction or sharpness processing is not to be carried out to said image data.

4. An image processing method according to claim 2, wherein said image processing of said image data comprises:
analyzing said image data and obtaining characteristic amounts regarding image quality;
determining correction amounts to be applied to said image data using standard values comprising image quality standards and said obtained characteristic amounts;
changing said determined correction amounts using said modified image processing control information; and
applying said changed correction amounts to said image data.

5. An image processing method according to claim 2, wherein said image processing of said image data comprises:
analyzing said image data and obtaining analysis values for each of multiple image quality parameters that indicate the image quality of said image data;
obtaining multiple standard values comprising standards for said multiple image quality parameters;
determining the correction amounts to be applied to said multiple image quality parameters for said image data using said obtained multiple standard values and said obtained multiple analysis values;
changing said determined correction amounts using said modified image processing control information; and
applying said changed correction amounts to said multiple image quality parameters for said image data.

6. An image processing method according to claim 1, wherein said modification information is obtained from a modification information storage module that stores said modification information.

7. An image processing method according to claim 1, wherein said modification information is included in said image processing control information.

8. An image processing method according to claim 1, wherein said modification information is generated based on the image output characteristics of said image output apparatus and said modification information is obtained by obtaining said generated modification information.

9. An image processing method of executing image processing of image data using at least one of either image processing control information that prescribes image processing conditions or shooting information at the time of shooting, said method comprising:
obtaining said image data;
obtaining at least one of said image processing control information or said shooting information associated with said obtained image data;
determining correction amounts to be applied to said obtained image data using at least one of either said obtained image processing control information or shooting information;
obtaining modification information for correcting said determined correction amounts in accordance with the image output characteristics of the image output apparatus to which the image-processed image data is to be output;
modifying said correction amounts using said obtained modification information; and
executing image processing of said obtained image data using said modified correction information.

10. An image processing method according to claim 9, wherein said correction amounts are determined based on the image output characteristics of said first image output apparatus, said image output apparatus is a second image output apparatus having image output characteristics different from those of said first image output apparatus, and said modification information is information for modifying said correction amount in order to bring the output images from said second image output apparatus close in quality to the output images from said first image output apparatus.

11. An image processing method according to claim 10, wherein said first image output apparatus is a printing apparatus, said second image output apparatus is a small-screen display device, determination of said correction amounts includes determination of a correction amount for at least one of either noise reduction or sharpness processing for said image data, and modification of said correction amounts is carried out by modifying said correction amounts such that at least one of either noise reduction or sharpness processing is not to be performed to said image data regardless of said determined correction amounts.

12. An image processing method according to claim 9, wherein said correction amount determination comprises:
analyzing said image data and obtaining analysis values for each of multiple image quality parameters that indicate the image quality of said image data;
obtaining multiple standard values comprising standards for said multiple image quality parameters; and
determining parameter correction amounts to be applied to said multiple image quality parameters for said image data using at least one of either said image processing control information or said shooting information, said obtained multiple standard values and said obtained multiple analysis values, and wherein said correction amount modification is performed by modifying said parameter correction amounts, and the image processing of said image data is carried out by applying said modified parameter correction amounts to the multiple image quality parameters for said image data.

13. An image processing method according to claim 9, wherein said modification information is obtained from a modification information storage module that stores said modification information.

14. An image processing method according to claim 9, wherein said modification information is generated based on the image output characteristics for said image output apparatus and said modification information is obtained by obtaining said generated modification information.

15. A display method for displaying images using image data associated with image processing control information that prescribes image processing conditions that reflect the image output characteristics of a printing apparatus, the display method comprising:
obtaining said image data;
obtaining said image processing control information associated with said obtained image data;
obtaining modification information for modifying said image processing control information such that it reflects the image output characteristics of the display device;
modifying said obtained image processing control information using said obtained modification information;
executing image processing of said obtained image data using said modified image processing control information; and
outputting images using said image data that underwent image processing.

16. A display method according to claim 15, wherein said image processing of said image data comprises:
analyzing said image data and obtaining characteristic amounts regarding image quality;
determining correction amounts to be applied to said image data using standard values comprising image quality standards and said obtained characteristic amounts;
changing said determined correction amounts using said modified image processing control information; and
applying said changed correction amounts to said image data.

17. A display method according to claim 15, wherein said image processing of said image data comprises:
analyzing said image data and obtaining analysis values for each of multiple image quality parameters that indicate the image quality of the image data;
obtaining multiple standard values comprising standards for said multiple image quality parameters;
determining correction amounts to be applied to said multiple image quality parameters for said image data using said obtained multiple standard values and said obtained multiple analysis values;
changing said determined correction amounts using said modified image processing control information; and
applying said changed correction amounts to said multiple image quality parameters for said image data.

18. A display method according to claim 17, wherein said correction amount determination is carried out such that the deviations between said obtained multiple standard values and said obtained multiple analysis values will be reduced or eliminated.

19. A display method according to claim 18, wherein said image quality parameters include at least one of either a noise parameter or a sharpness parameter, and the modification of said image processing control information is carried out by setting the correction amount for at least one of either said noise parameter or said sharpness parameter to zero.

20. A display method according to claim 15, wherein said modification information is obtained from a modification information storage module that stores said modification information.

21. An image processing apparatus that performs image processing of image data using image processing control information and outputs to a connected image output apparatus the image-processed image data, wherein the that image processing control information prescribes image processing conditions, said image processing apparatus comprising:
an image data obtaining module that obtains said image data;
an image processing control information obtaining module that obtains said image processing control information associated with said obtained image data;
a modification information obtaining module that obtains for an image output apparatus modification information for modifying said image processing control information in accordance with the image output characteristics of said image output apparatus;
an image processing control information modification module that modifies said obtained image processing control information using said obtained modification information;
an image processing module that executes image processing of said obtained image data using said modified image processing control information; and
an image data output module that outputs to said image output apparatus said image data that underwent image processing.

22. An image processing apparatus that performs image processing of image data using at least one of either image processing control information or shooting information pertaining to the time of shooting and outputs to a connected image output apparatus the image-processed image data, wherein the image processing control information prescribes image processing conditions, said image processing apparatus comprising:
an image data obtaining module that obtains said image data;
an association information obtaining module that obtains at least one of either said image processing control information or shooting information associated with said obtained image data;
a correction amount determining module that determines correction amounts to be applied to said obtained image data using at least one of either said obtained image processing control information or shooting information;
a modification information obtaining module that obtains for said image output apparatus modification information for modifying said determined correction amounts in accordance with the image output characteristics of said image output apparatus;
an image processing module that executes image processing of said obtained image data using said modified correction amounts; and
an image data output module that outputs to said image output apparatus said image data that underwent image processing.

23. A display device that displays images using image data associated with image processing control information, wherein the image processing control information prescribes image processing conditions that reflect the image output characteristics of a printing apparatus, said display device comprising:
an image data obtaining module that obtains said image data;
an image processing control information obtaining module that obtains said image processing control information associated with said obtained image data;
a modification information obtaining module that obtains modification information for modifying said image processing control information so as to reflect the image output characteristics of the display device;
an image processing control information modification module that modifies said obtained image processing control information using said obtained modification information;
an image processing module that executes image processing of said obtained image data using said modified image processing control information; and
an image output module that outputs images using said image data that underwent image processing.
